(19) United States
(12) Patent Application Publication
(10) Pub. No.: US 2025/0274689 A1
(43) Pub. Date: Aug. 28, 2025

(54) Smart Wearable Device

(71) Applicant: AAC ACOUSTIC TECHNOLOGIES (SHENZHEN) CO., LTD., Shenzhen (CN)

(72) Inventor: Meng Lin, Shenzhen (CN)

(21) Appl. No.: 18/744,583

(22) Filed: Jun. 14, 2024

Related U.S. Application Data
(63) Continuation of application No. PCT/CN2024/078204, filed on Feb. 23, 2024.

(51) Int. Cl. H04R 1/02; G02B 27/01; G06F 3/01; H04R 1/08

(52) U.S. Cl. CPC H04R 1/028; G02B 27/017; G06F 3/017; H04R 1/086; G02B 2027/0178; H04R 2499/11

(57) ABSTRACT

The present invention provides a smart wearable device including a glass frame and a pair of temples. Each temple includes a shelf having a receiving room, a speaker unit and a microphone unit accommodated in the receiving room. The speaker unit includes a first sounding surface and a second sounding surface. The shelf includes an upper wall, a lower wall, and an outer wall. The outer wall provides with an auxiliary sound hole. The auxiliary sound hole is communicated with the second sounding surface. The outer wall provides with a microphone sound hole. The microphone sound hole is communicated with the microphone unit. An ultrasonic signal emitted from auxiliary sound hole reaches the microphone unit from the microphone sound hole after reflection. The smart wearable device of the present invention is suitable for gesture recognition or mode adjustment, and has more diversified functions.

### FIELD OF THE PRESENT INVENTION

The present invention relates to the field of electronic equipment, and more particularly, to a smart wearable device suitable for gesture recognition or mode adjustment.

### DESCRIPTION OF RELATED ART

With the rapid development of the electronics industry, smart devices with playback functions are also rapidly emerging. That is, on the basis of conventional smart devices, structures such as sound-generating devices and microphones are added, so that the smart devices can play the functions of music playback and phone calls. Such as smart glasses, VR equipment, mobile phones, tablets, etc.

In the related art, smart wearable devices are generally equipped with a single sounding diaphragm on the speaker and each only has one main sound hole, which can only realize the playback of sound. The sound is emitted from the sounding diaphragm, transmitted to an external space through the main sound hole, and finally reaches the human ear. However, in the related art, gesture control cannot be realized, and the diversity of functions of smart wearable devices is not enough.

Therefore, it is desired to provide a new smart wearable device which can overcome the above problems.

### SUMMARY

In view of the above, the embodiments of the present invention provide a new smart wearable device, and the smart wearable device is suitable for gesture recognition or mode adjustment.

The present invention provides a smart wearable device including a glass frame and a pair of temples extending backward from both sides of the glass frame. Each temple includes a shelf having a receiving room, a speaker unit and a microphone unit accommodated in the receiving room. The speaker unit includes a first sounding surface and a second sounding surface arranged back-to-back with the first sounding surface. The shelf includes an upper wall, a lower wall opposite to the upper wall, and an outer wall connecting the upper wall and lower wall. The lower wall provides with a main sound hole. The outer wall provides with an auxiliary sound hole. The main sound hole is communicated with the first sounding surface, and the auxiliary sound hole is communicated with the second sounding surface. The outer wall also provides with a microphone sound hole near the auxiliary sound hole. The microphone sound hole is communicated with the microphone unit. An ultrasonic signal emitted from auxiliary sound hole reaches the microphone unit from the microphone sound hole after reflection.

As an improvement, the speaker unit includes a first speaker and a second speaker, the first sounding surface located on the first speaker and the second sounding surface located on the second speaker.

As an improvement, the speaker unit is one speaker, the first sounding surface provided on one side of the speaker and the second sounding surface provided on the other side of the speaker.

As an improvement, the smart wearable device further includes a first bracket supporting the speaker unit in the receiving room, one end of the first bracket fixed with the upper wall of the shelf, and the other end of the first bracket fixed with the lower wall of the shelf, a first front cavity formed between the first bracket and the first sounding surface of the speaker unit, the first front cavity guiding a sound emitted by the first sounding surface out of the main sound hole.

As an improvement, the smart wearable device further includes a second bracket supporting the speaker unit in the receiving room, a second front cavity formed by the second bracket, the second sounding surface of the speaker unit, and the outer wall of the shelf, the second front cavity guiding a sound emitted by the second sounding surface out of the auxiliary sound hole.

As an improvement, the speaker unit has an inner cavity, the first bracket, the second bracket and the shelf cooperatively forming a back cavity communicated with the inner cavity of the speaker unit, the back cavity arranged around the speaker unit, the upper wall of the shelf provided with a vent hole communicated to the back cavity.

As an improvement, the first bracket includes a main body and an extension body extending from the main body, the extension body having a shape corresponding to the main sound hole, a foam disposed between the extension body and the shelf surrounding to form the main sound hole.

As an improvement, the foam is fixed to the shelf or/and the first bracket by gluing.

As an improvement, the smart wearable device further includes a plurality of meshes correspondingly attached to the main sound hole and the auxiliary sound hole.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a smart wearable device in accordance with one embodiment of the present invention.

FIG. 2 is an illustrative isometric view of the temple of the smart wearable device of FIG. 1.

FIG. 3 is another illustrative isometric view of the temple of FIG. 2 from another perspective.

FIG. 4 is a partially exploded view of the temple of the smart wearable device of FIG. 2.

FIG. 5 is an exploded view of the temple of the smart wearable device of FIG. 2.

FIG. 6 is an illustrative cross-sectional view of the smart wearable device taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

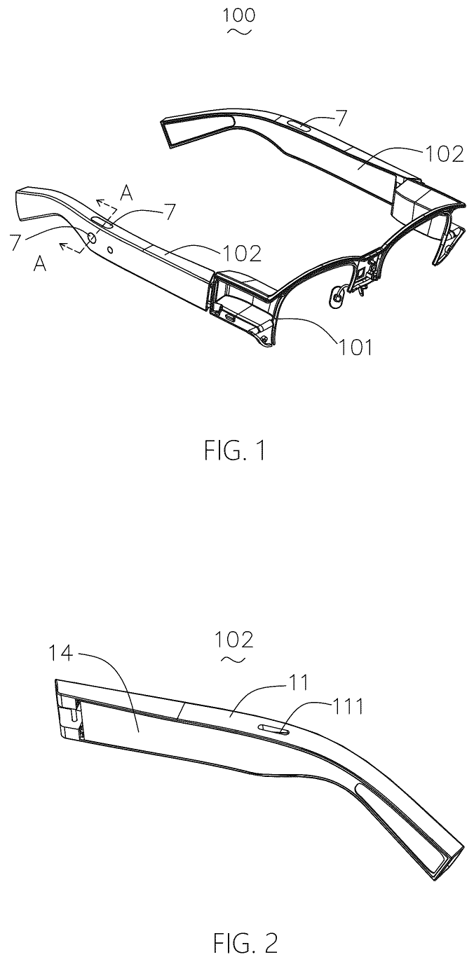

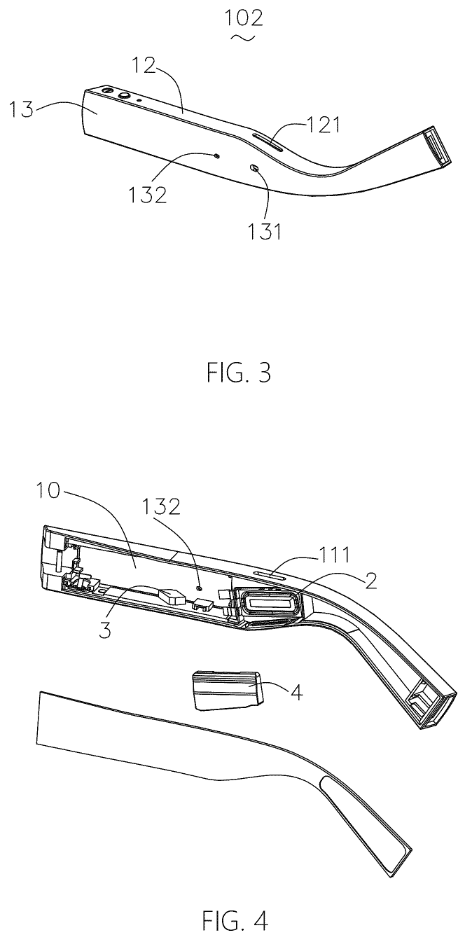

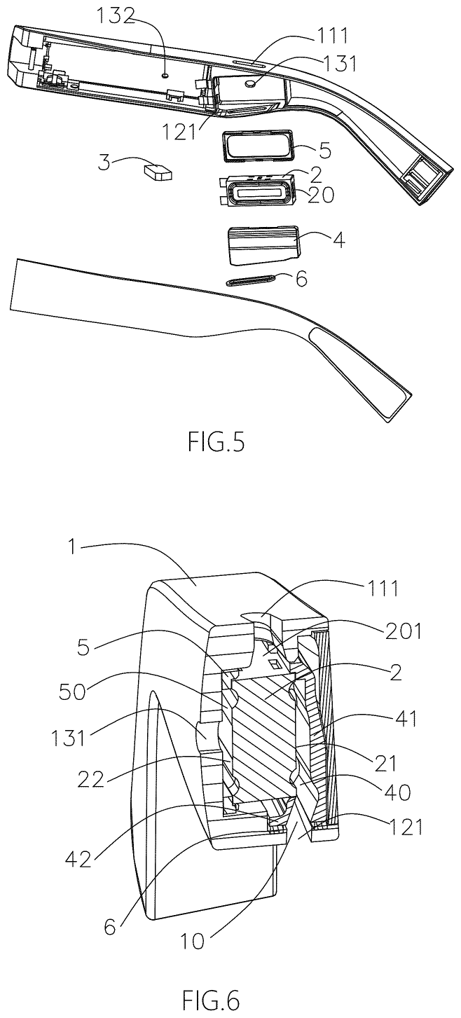

Referring to the FIGS. 1-6, the present invention provides one embodiment of a smart wearable device 100. The smart wearable device 100 is suitable for gesture recognition or mode adjustment. The smart wearable device 100 includes a glass frame 101 and a pair of temples 102 extending backward from both sides of the glass frame 101. Lenses can be installed on the glass frame 101. Two temples 102 have the same structure, and two temples 102 have a centrally symmetrical structure.

Each temple 102 includes a shelf 1 having a receiving room 10, a speaker unit 2 and a microphone unit 3 accommodated in the receiving room 10, a first bracket 4 and a second bracket 5 supporting the speaker unit 2 in the receiving room 10, a foam 6 and a plurality of meshes 7.

The shelf 1 includes an upper wall 11, a lower wall 12 opposite to the upper wall 11, and an outer wall 13 and an inner wall 14 connecting the upper wall 11 and lower wall 12. The inner wall 14 is located at a side of the shelf 1 close to the human ear, and the outer wall 13 is located away from the human ear. The upper wall 11 is provided with a vent hole 111. The lower wall 12 is provided with a main sound hole 121. The outer wall 13 is provided with an auxiliary sound hole 131 and a microphone sound hole 132 near the auxiliary sound hole 131. The shelf 1 can be a split structure or an integrated structure.

The speaker unit 2 includes a first sounding surface 21 and a second sounding surface 22 arranged back-to-back with the first sounding surface 21. The speaker unit 2 has an inner cavity 20. The vent hole 111 is communicated with the inner cavity 20. The inner cavity 20 is a cavity formed by a space between the first sounding surface 21 and the second sounding surface 22 of the speaker unit 2. The main sound hole 121 is communicated with the first sounding surface 21 of the speaker unit 2, and the auxiliary hole 131 is communicated with the second sounding surface 22 of the speaker unit 2.

Specifically, the speaker unit 2 is one speaker, the first sounding surface 21 is provided on one side of the speaker and the second sounding surface 22 is provided on the other side of the speaker. In this embodiment, in the smart wearable device 100, there is only one speaker with double-sided sounding. And the speaker also has only one inner cavity 20. In another embodiment, the speaker unit 2 includes a first speaker and a second speaker. The first sounding surface 21 locates on the first speaker and the second sounding surface 22 locates on the second speaker. In this situation, the smart wearable device 100 has two speakers which can sound. Each of the two speakers has the inner cavity, and the inner cavities of the two speakers are communicated to each other.

The first sounding surface 21 and the second sounding surface 22 can emit sound in the normal working mode. In other working modes, the second sounding surface 22 can emit an ultrasonic signal and emit it through the auxiliary sound hole 131.

The microphone unit 3 locates in the shelf 1 and is communicated with the microphone sound hole 132. The ultrasonic signal emitted from auxiliary sound hole 131 reaches the microphone unit 3 from the microphone sound hole 132 after reflection by an obstacle, so that the gesture recognition function of the smart wearable device 100 can be realized. Alternatively, this process can identify the distance between other people in the surrounding environment and the user, what can be as a reference condition for mode adjustment. Specifically, if it is recognized that others are far away from the user, the treble mode can be turned on, and if it is recognized that the distance between others and the user is close, the silent mode or bass mode can be turned on. Therefore, the smart wearable device 100 of the present invention achieves the diversified functions.

One end of the first bracket 4 is fixed with the upper wall 11 of the shelf 1, and the other end of the first bracket 4 is fixed with the lower wall 12 of the shelf 1. A first front cavity 40 is formed between the first bracket 4 and the first sounding surface 21 of the speaker unit 2. The first front cavity 40 guides a sound emitted by the first sounding surface 21 out of the main sound hole 121. The first bracket 4 includes a main body 41 and an extension body 42 extending from the main body 41. The extension body 42 has a shape corresponding to the main sound hole 121. The foam 6 is disposed between the extension body 42 and the shelf 1 surrounding to form the main sound hole 121. The foam 6 has an annular shape and is fixed to the shelf 1 or/and the first bracket 4 by gluing.

A second front cavity 50 is cooperatively formed by the second bracket 5, the second sounding surface 22 of the speaker unit 2, and the outer wall 13 of the shelf 1. The second front cavity 50 guides a sound emitted by the second sounding surface 22 out of the auxiliary sound hole 131. The second bracket 5 is an annular structure. Alternatively, another foam 6 can be further disposed between the second bracket 5 and the shelf 1 surrounding to form the auxiliary sound hole 131. The foam 6 also can be fixed to the shelf 1 or/and the second bracket 5 by gluing.

The first bracket 4, the second bracket 5 and the shelf 1 cooperatively form a back cavity 201 communicated with the inner cavity 20 of the speaker unit 2. The back cavity 201 has an annular shape and is arranged around the speaker unit 2. The back cavity 201 is communicated to the vent hole 111 of the shelf 1.

The plurality of meshes 7 are correspondingly attached to the vent hole 111, or/and the main sound hole 121, or/and the auxiliary sound hole 131, or/and the microphone sound hole 132. The meshes 7 can prevent dust or water vapor from entering the receiving room 10 in the temple 102.

Comparing with the related art, the present invention provides a smart wearable device including a glass frame and a pair of temples extending backward from both sides of the glass frame. Each temple includes a shelf having a receiving room, a speaker unit and a microphone unit accommodated in the receiving room. The speaker unit includes a first sounding surface and a second sounding surface arranged back-to-back with the first sounding surface. The shelf includes an upper wall, a lower wall opposite to the upper wall, and an outer wall connecting the upper wall and lower wall. The lower wall provides with a main sound hole. The outer wall provides with an auxiliary sound hole. The main sound hole is communicated with the first sounding surface, and the auxiliary sound hole is communicated with the second sounding surface. The outer wall also provides with a microphone sound hole near the auxiliary sound hole. The microphone sound hole is communicated with the microphone unit. An ultrasonic signal emitted from auxiliary sound hole reaches the microphone unit from the microphone sound hole after reflection. The smart wearable device of the present invention is suitable for gesture recognition or mode adjustment, and has more diversified functions.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A smart wearable device, comprising:
a glass frame; and
a pair of temples extending backward from both sides of the glass frame, each temple comprising:
a shelf having a receiving room, the shelf comprising:
an upper wall;
a lower wall opposite to the upper wall, the lower wall provided with a main sound hole; and
an outer wall connecting the upper wall and lower wall, the outer wall provided with an auxiliary sound hole and a microphone sound hole near the auxiliary sound hole;
a speaker unit accommodated in the receiving room, the speaker unit comprising a first sounding surface and a second sounding surface arranged back-to-back with the first sounding surface, the first sounding surface communicated with the main sound hole, and the second sounding surface communicated with the auxiliary sound hole; and
a microphone unit accommodated in the receiving room, the microphone sound hole communicated with the microphone unit;
wherein an ultrasonic signal emitted from auxiliary sound hole reaches the microphone unit from the microphone sound hole after reflection.

2. The smart wearable device as described in claim 1, wherein the speaker unit comprises a first speaker and a second speaker, the first sounding surface located on the first speaker and the second sounding surface located on the second speaker.

3. The smart wearable device as described in claim 1, wherein the speaker unit is one speaker, the first sounding surface provided on one side of the speaker and the second sounding surface provided on the other side of the speaker.

4. The smart wearable device as described in claim 1, wherein the smart wearable device further comprises a first bracket supporting the speaker unit in the receiving room, one end of the first bracket fixed with the upper wall of the shelf, and the other end of the first bracket fixed with the lower wall of the shelf, a first front cavity formed between the first bracket and the first sounding surface of the speaker unit, the first front cavity guiding a sound emitted by the first sounding surface out of the main sound hole.

5. The smart wearable device as described in claim 4, wherein the smart wearable device further comprises a second bracket supporting the speaker unit in the receiving room, a second front cavity formed by the second bracket, the second sounding surface of the speaker unit, and the outer wall of the shelf, the second front cavity guiding a sound emitted by the second sounding surface out of the auxiliary sound hole.

6. The smart wearable device as described in claim 5, wherein the speaker unit has an inner cavity, the first bracket, the second bracket and the shelf cooperatively forming a back cavity communicated with the inner cavity of the speaker unit, the back cavity arranged around the speaker unit, the upper wall of the shelf provided with a vent hole communicated to the back cavity.

7. The smart wearable device as described in claim 4, wherein the first bracket comprises a main body and an extension body extending from the main body, the extension body having a shape corresponding to the main sound hole, a foam disposed between the extension body and the shelf surrounding to form the main sound hole.

8. The smart wearable device as described in claim 7, wherein the foam is fixed to the shelf or/and the first bracket by gluing.

9. The smart wearable device as described in claim 1, wherein the smart wearable device further comprises a plurality of meshes correspondingly attached to the main sound hole and the auxiliary sound hole.
